(19) United States
(12) Patent Application Publication
(10) Pub. No.: US 2009/0245137 A1
(43) Pub. Date: Oct. 1, 2009

(54) HIGHLY AVAILABLE VIRTUAL STACKING ARCHITECTURE

(75) Inventors: Susan K. Hares, Saline, MI (US); Allan C. Rubens, Ann Arbor, MI (US); Andrew Adams, Ann Arbor, MI (US)

Correspondence Address: PERKINS COIE LLP, P.O. BOX 1208, SEATTLE, WA, 98111-1208, US

(73) Assignee: Green Hills Software, Inc., Ann Arbor, MI (US)

(21) Appl. No.: 12/397,302

(22) Filed: Mar. 3, 2009

Related U.S. Application Data
(60) Provisional application No. 61/033,350, filed on Mar. 3, 2008.

(51) Int. Cl. H04L 12/28

(52) U.S. Cl. 370/254; 709/223

(57) ABSTRACT

At least one embodiment of the present invention provides a single High Availability virtual switching architecture that allows for sub convergence times in the event of a switch or switch link failure. In some instances, the High Availability architecture uses an adaptation of an ISIS protocol to leverage separation of topology calculation and propagation of network management configuration to achieve sub-second convergence.

### CLAIM OF PRIORITY AND CROSS REFERENCE TO RELATED APPLICATIONS

This application claims priority to U.S. Provisional Patent Application No. 61/033,350, entitled HIGHLY AVAILABLE VIRTUAL SWITCHING ENVIRONMENT, filed Feb. 3, 2008, which is hereby incorporated by reference in its entirety.

This application hereby incorporates by reference in their entirety each of the following U.S. patent applications: U.S. patent application Ser. No. 11/121,163 entitled REMOTE MANAGEMENT OF COMMUNICATION DEVICES, filed May 2, 2005; U.S. patent application Ser. No. 11/121,162 entitled VIRTUALIZATION OF CONTROL SOFTWARE FOR COMMUNICATION DEVICES, filed May 2, 2005 (now abandoned); and U.S. patent application Ser. No. 11/347,834 entitled LAYER 2 VIRTUAL SWITCHING ENVIRONMENT, filed Feb. 2, 2005.

### FIELD

The following disclosure is directed to computer networks, and more specifically to a high availability virtual switching environment.

### BACKGROUND

Enterprise networks should be highly available to ensure the availability of mission-critical applications. Reliability implies that the system performs its specified task correctly. Availability means that the system is ready for immediate use. Network enterprises utilize High Availability architectures to ensure that the enterprises' applications are functional and available for use. High Availability architectures are implemented by introducing hardware and/or software reliability to automatically identify and respond to link failures.

In addition to using reliable hardware and/or software, High Availability architectures (e.g., stacked switch architectures) also introduce redundant devices (e.g., redundant L2 switches) to ensure resilience against the loss of one or more devices. High Availability architectures should also define network topologies (e.g., switch stacking topologies) to ensure that there is no single point of failure and to allow fast recovery around any device or link failure.

In the event of a link or device failure, prior art High Availability switches provide fast failover of the forwarding planes of switches. However, the network management functions of the control plane generally do not fail over immediately because of the time taken by network management to readjust to the loss of one or more switches or switch links in a stacked switch environment. This delay in the control plane failover of the network management causes the switch component to be unavailable for activities such as reconfiguration, status query responses, security defense, etc. Additionally, such delay leaves the control plane component vulnerable to denial or other service attacks.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 schematically illustrates an embodiment of a virtual switch stack configuration arranged in a High Availability architecture;

FIG. 2 illustrates an embodiment of the virtual switches configured in a stacking switch architecture;

FIG. 3 illustrates an exemplary structure of the switch infrastructure protocol;

FIG. 4 illustrates an exemplary structure and implementation of the intra-switch topology protocol;

FIG. 5 depicts a stacked virtual switching environment that uses a FIB forwarding table for intra-switch communication; and

FIG. 6 depicts a stacked virtual architecture with an elected management switch.

### SUMMARY OF THE DESCRIPTION

At least one embodiment of the present disclosure provides a single High Availability switching architecture that allows for sub-second convergence times in the event of a switch or switch link failure. In embodiments of the invention, the High Availability architecture utilizes one or more of the following features to achieve the sub-second convergence:
Adaptation of an Intermediate Standard—Intermediate Standard (ISIS) protocol to leverage the separation of topology calculation and propagation of network management configuration;
Use of a deterministic real-time kernel;
Creation of a single network management image based on an adaptation of an Advance Management Infrastructure (AMI) interface to operate in a stacked switching environment;
Prioritization of intra-switch traffic based on the type of information to be propagated. Switch identity and topology configuration information are assigned a higher priority over L2 and network management configuration information;
Coordination of management agents of each switch in the stacked switching environment using a master agent (e.g., a master AMI agent) to reduce load on the intra-switch management functions;
Adaptation of an intra-switch protocol to perform a master election process to elect one of the management agents as the master agent;
Parallel running of control functions on all components switching on each processor.

### DETAILED DESCRIPTION

The present invention may be embodied in several forms and manners. The description provided below and the drawings show exemplary embodiments of the invention. Those of skill in the art will appreciate that the invention may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

In computer network architectures, several computing devices (e.g., personal computers, servers, mobile phones with network capability, printers, etc.) are coupled and connected to a central network (e.g., a VLAN network) through one or more network switches.

Layer 2 (L2) switches can contain hundreds of ports within a single switch. In a physical switch stack, several switch modules are physically “stacked” above one another to provide, for example, a redundant array of switches. The redundant array of switches are intended to ensure that network connectivity is not disrupted even when one or more of the switch modules fail (i.e., when a failover event occurs).

### Virtual Switches

A virtual switch, as described herein, is configured to perform regular switching functions of a physical network switch. However, the virtual switches, which may replace a single or a multiple number of physical switches, may all be embedded in a single physical switch or across multiple physical switches. The virtual switches may run on one or more processors. A virtual environment allows logical stacking of switches to replace the physical stacking. The ports in a particular physical switch may be stacked into a logical scheme that allows movement or grouping of ports.

Detailed information on virtual switches and the virtual switching environment is provided in U.S. patent application Ser. No. 11/347834 entitled LAYER 2 VIRTUAL SWITCHING ENVIRONMENT, filed Feb. 2, 2005, which is hereby incorporated by reference in its entirety.

In embodiments, the virtual switches described herein are configured based on a High Availability architecture. Network packets originating from various network applications cross different network segments (e.g., an enterprise backbone, an enterprise edge, a service provider edge, a service provider core, etc.). To provide continuous access (i.e., high availability) to the network applications, the switching environment should be resilient to faults or failures in one or more of the virtual switches. The following sections describe such a resilient architecture of a High Availability virtual switch stack.

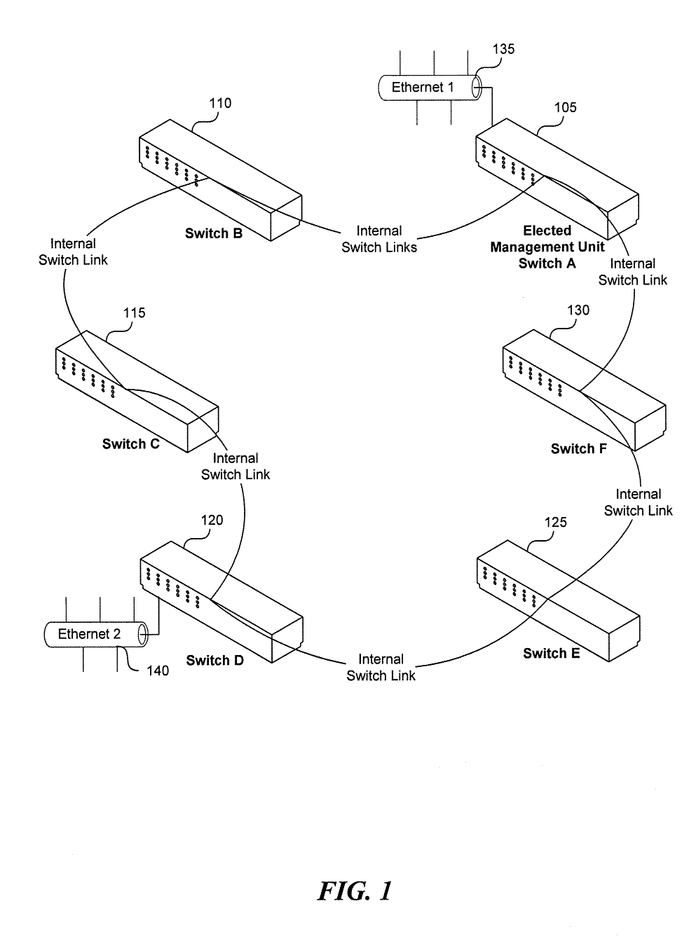

FIG. 1 schematically illustrates an embodiment of a virtual switch stack configuration arranged in a High Availability architecture. Switches A-F (105-130) are virtual switches arranged in a virtual stack configuration. Each of the virtual switches communicates with another virtual switch via an internal switch link. In some instances, an application programming interface provides such a communication link among the switches. The application programming interface utilizes an intra-switch communication protocol to communicate with each of virtual switches. Detailed functionality of the application programming interface and the intra-switch communication protocol are described in the following sections.

In some instances of the High Availability architecture, one of the virtual switches is assigned (or elected) as a management unit when the virtual switch stack is powered on. As described in detail further below, an intra-switch topology protocol executes an election routine to enable one of the virtual switches to be elected as the management unit. If the elected management switch fails, the intra-switch topology protocol executes the election routine to automatically elect another management switch from the remaining virtual switches. In some instances, the elected management switch maintains configuration information related to the network management and topology management. The elected management switch propagates such configuration information to the remaining switches as and when there is an update to the configuration information.

The L2 virtual switches illustrated in FIG. 1 are configured to learn MAC addresses received on any of the logical access ports. For example, access port is associated with a specific VLAN through, for example, an Ethernet connectivity 135. Switch A 105 consequently learns a MAC address associated with the VLAN of Ethernet 1 135 through the access port 106. In the stacked environment, the VLAN and the MAC address associated with the VLAN are propagated from the virtual switch (e.g., 105) that learns the information to the remaining virtual switches in the stacked environment.

In some instances, the High Availability architecture utilizes an internal intra-switch stacking forwarding protocol to enable the first switch (i.e., the first switch to learn the MAC address) to propagate the information to the remaining switches. The intra-switch stacking forwarding protocol may provide a forwarding sequence to forward the information. By way of a non-limiting example, the forwarding sequence may indicate that information learned by switch D 120 should be propagated to switch B 110 by hopping from switch D 120 to switch C 115 and then to switch B 110, while the sequence may indicate that the information to switch F 130 should propagate through switch E 125. Such an example illustrates the shortest hopping distance calculations executed by the intra-switch stacking forwarding protocol.

### Virtual Stacking Switch Architecture

In embodiments, the virtual stacking switch architecture, as defined by the High Availability switching architecture, contains at least three components: the virtual switches, an internal infrastructure of the virtual switches (i.e., the switch topology), and network management elements (i.e., management software). Each of these components is configured to enable a fast fail-over upon the loss or addition of one of the virtual switches in the topology, as will be explained below.

The network management software of the virtual stacking switch architecture uses GateD unified switching code and GateD stack switching code over a IPV9/IPV6 stack. The GateD unified switching environment architecture supports L2 and L3 level communications, as well as Multiprotocol Label Switching (MPLS) and Wireless Access Points (WAP) protocols. These components of the network management software provide the full failover functionality of the High Availability architecture.

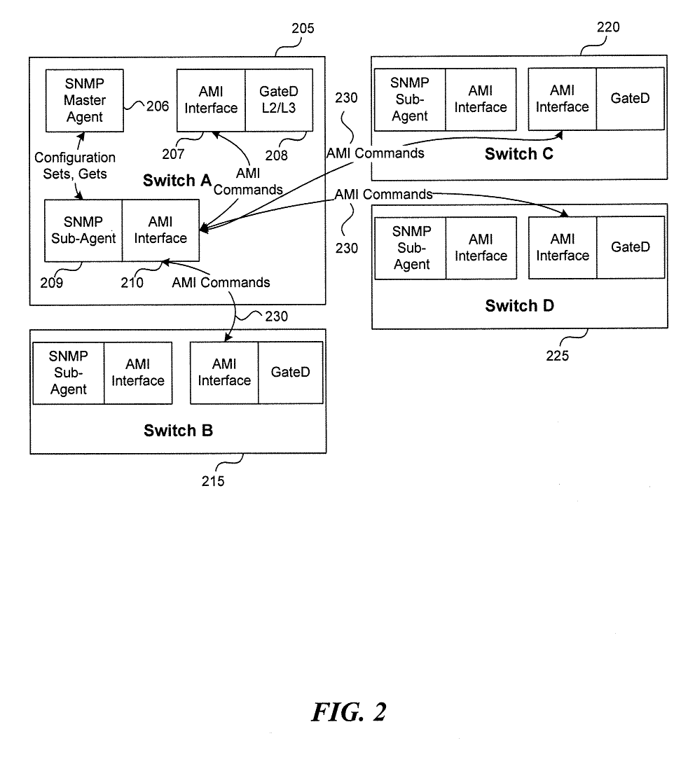

FIG. 2 illustrates an embodiment of the virtual switches configured in a stacking switch architecture. The embodiment illustrated in FIG. 2 refers to an SNMP agent architecture, where each of the virtual switches comprises an Advanced Management Infrastructure (AMI) 210/SNMP agent 209 interface. As indicated in FIG. 2, an SNMP master agent 206 in a particular virtual switch 205 interfaces with the SNMP/AMI interface to propagate network management configuration information etc. The SNMP/AMI interface then uses an application programming interface 230 (e.g., AMI interfacing commands) to propagate, for example, the network management configuration information to the SNMP/AMI interfaces of the remaining virtual switches (e.g., 220, 215, 225) present in the topology. The SNMP/AMI interface of a particular virtual switch box is referred to herein as a management agent of that particular virtual switch box.

The management agent, using the management software, receives requests or updates (e.g., update of network management configuration information, forwarding information, etc.) through the application programming interface. The management agent of the virtual switch box then performs suitable actions based on the received request or update (e.g., store the update in association with the virtual switch, etc.). Concepts and details related to the AMI interface, AMI commands, the management agent, etc. are explained in detail in U.S. patent application Ser. No. 11/121163 entitled REMOTE MANAGEMENT OF COMMUNICATION DEVICES, filed May 2, 2005, which is hereby incorporated by reference in its entirety.

The management software (i.e., the virtual stacking software) of the High Availability virtual switching architecture comprises at least three components: switch infrastructure, switch infrastructure protocol, and management unit failover and election, each of which are described in detail below.

### Switch Infrastructure and Switch Infrastructure Protocol

In one embodiment, the stacking switch architecture links the switches together in a single switch topology. To achieve sub-second convergence on failover, the internal switch topology should converge on another topology, for example, within 5 seconds for a three-level switch topology. Similarly, the per-switch convergence rate of the convergence protocol should be, for example, less than a second to achieve the sub-second convergence. The stacking switch architecture may support any number of topologies. For example, the stacking switch topologies may be meshed, or tiered, or a combination thereof. The management software is designed such that the stacking switch architecture can handle, for example, 50,000 VLANS for a virtual switch with 200 MAC addresses.

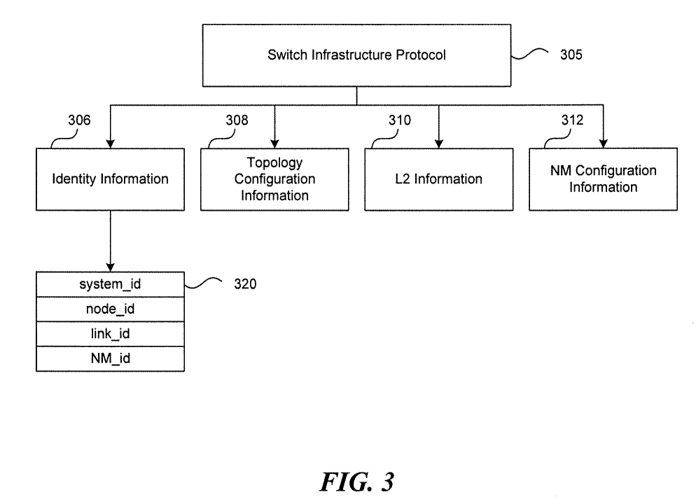

FIG. 3 illustrates an exemplary structure of the switch infrastructure protocol. The intra-switch communication protocol includes a switch infrastructure protocol 305 that carries, for example, identity information of the virtual switches of the stacked topology 306, topology configuration information of the stacked virtual switches 308, L2 information associated with the network packets handled by the virtual switches 310, and network management configuration information of the stacked virtual switches 312.

The identity information 306 carried by the switch infrastructure protocol further includes switch identifiers, port information of the virtual switches, and hardware configuration of the switches. The topology information 308 includes information about links between switches. The switch infrastructure protocol allows multiple links between any two virtual switches. The L2 information 310 includes MAC addresses (that are either learned by the switches or configured into the switches), VLAN information, and VLAN/MAC mappings.

In one embodiment, the switch identifier of the identity information 306 includes four sub-components 320: a system-id, a node-id, a link-id, and a Network Management (NM)-id. In some instances, the switch-ID is a composite of the L2 switch-id, the node-id, and a security identifier. The node-id identifies the switch box. The system-id identifies the stacked switch. In one illustrative example, if the node-id is 0x00:02, the security id 0x34, and the L2 system-id is 0x49:01:02:03, then the system-id would be 0x49:01:02:03:04:00:02:34.

The L2 system-id ensures that the ports or other hardware not configured for a particular physical switch box are not allowed into the virtual switch configuration. Nodes that do not have the appropriate security field would not be allowed within the intra-switch topology. This ensures that any switch erroneously plugged into the virtual switch does not show up on the topology.

In embodiments, the system-id is used in the intra-switch protocol. The NM-id is, for example, an internal IP address from an IP private address space of the topology. The NM-id is available only after the intra-switch topology protocol converges. In some instances, the NM-id enables NM agents (AMI, SNMP, CLI, DHCP, X.509, etc.) to propagate traffic through the intra-switch backbone.

The intra-switch communication protocol (or specifically, the switch infrastructure protocol) prioritizes the sending, receiving, or processing of the information included in the switch infrastructure protocol. In some instances, the switch infrastructure protocol assigns a higher priority to the identity information and topology configuration of the stacked virtual switches, and assigns a lower priority to the L2 information and network management configuration information.

The management agent in each of the virtual switches contains software or hardware (or a combination thereof) to respond to a priority shift while receiving any intra-switch traffic. For example, the management agent of a particular virtual switch may preempt lower priority intra-switch traffic (e.g., L2 information, etc.) when it encounters receipt of another higher priority intra-switch traffic (e.g., topology configuration information).

In non-limiting illustrations, the switch infrastructure protocol uses existing GateD protocol components for shortest path calculations. For example, a common SPF code that is used by the Intermediate State—Intermediate State (ISIS) protocol is used for the shortest path calculation. Similarly, in some such instances, the heart-beat mechanism of the switch infrastructure protocol uses existing ISIS protocol heartbeat functions. In some instances, a BFD protocol may also be used to implement the heartbeat mechanism. In some instances, the AMI configuration information 312 is flooded to all virtual switches in the stacked topology or addressed to a specific virtual switch using the intra-switch communication protocol. Such AMI configuration information is used, for example, in the election of a management switch, which will be explained in greater detail further below.

### Intra-Switch Topology Protocol

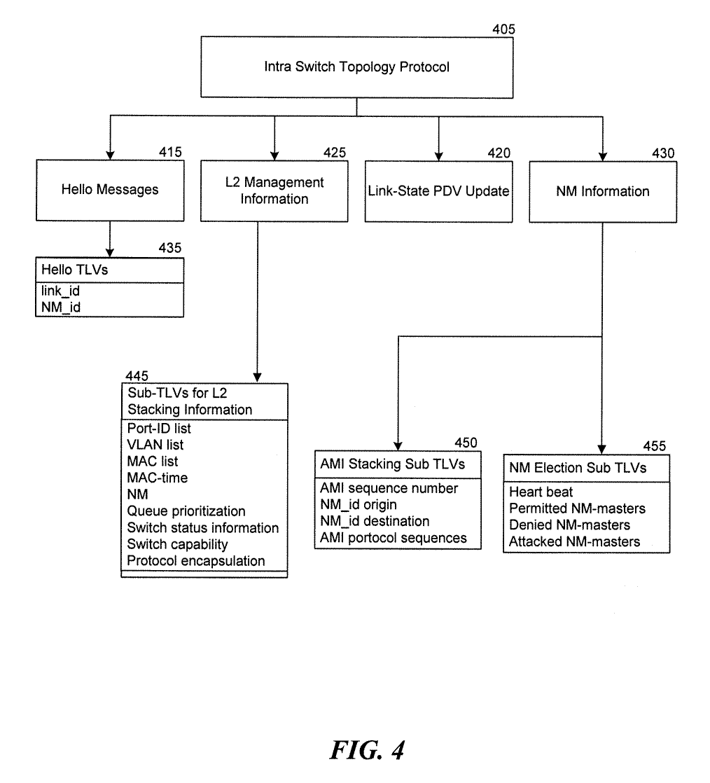

FIG. 4 illustrates an exemplary structure and implementation of the intra-switch topology protocol. The intra-switch topology protocol 405 includes several components. Examples of such components include: Hello messages (to establish a connection with a virtual switch and to implement the heartbeat mechanism) 415, a link-state PDU to update the stack topology information 420, L2 management information 425, and network management (NM) information 430. Similar to the switch infrastructure protocol, the intra-switch topology protocol, in some instances, is an extended version of the ISIS protocol. The ISIS protocol already has the capability to send MAC addresses and opaque TLVs. The modified version of the ISIS protocol is used to implement the intra-switch topology protocol.

The intra-switch topology may be calculated, by way of a non-limiting example, based on the LSP information on systems and links. As previously discussed, the intra-switch topology is assigned a high priority by the intra-switch communication protocol during the processing of network packets. The intra-switch topology protocol uses information attached to each switch node, which includes, for example, general L2 information (e.g., information related to a port, VLAN, MAC, etc.), NM information, etc.

The following sections discuss the changes made to the ISIS protocol to implement the intra-switch topology protocol in certain instances of the invention. An ISIS Hello TLV 435 uses system-id information previously established using the switch infrastructure protocol. In one embodiment, the ISIS Hello TLV fields 435 contains a link-ID TLV field (e.g., in a TLV of 0xYY01 that identifies switch topology), and an NM TLV field that contains an NM-id and an active master NM flag.

Additionally, in some instances, the ISIS LSPs are updated to include one or more of the following TLV fields:
TLV for grouping of L2 stacking information
TLV for AMI Configuration
TLV for NM election
TLV for ARP information

The TLV for the L2 management information component 425 of the intra-switch topology protocol contains the following sub-TLVs 445:
Sub-TLV for Port ID list
Sub-TLV for VLAN list
Sub-TLV for MAC list
Sub-TLV for time value for MAC list
Sub-TLV the Network Manager
Sub-TLV queue load values with flags for queue prioritization
Sub-TLV status information per switch in the stacked switch
Sub-TLV switch capability information
Sub-TLV protocol encapsulations

Protocol encapsulations may include L2 protocols (STP, RSTP, MSTP, IGMPv2/v3, MLDv2), L2 encapsulations, L4 protocols, application protocols or stack specific protocols. The encapsulations enable opaque transmission of these protocols from one virtual switch to another. Additionally, in some instances, the queue prioritization flags may be based on differentiated services, TOS bits, etc.

The TLV for the AMI stacking may contain one or more of the following sub-TLVs 450:
Sub-TLV AMI sequence number
Sub-TLV NM id of AMI originator
Sub-TLV NM id of AMI destination (if point-to-point)
Sub-TLV Sequences of AMI TLVs as defined by the AMI protocol (each of the AMI TLVs serves as a Sub-TLV in this protocol).

The TLV for NM election may contain one or more of the following sub-TLVs 455:
Sub-TLV for heart beat mechanism
Sub-TLV indicating permitted NM masters
Sub-TLV indicating denied NM masters
Sub-TLV indicating attacked NM masters

The TLV for ARP may contain one or more of the following sub-TLVs:
Sub-TLV indicating ARP paring (VLAN, MAC, IP address tuples)
Sub-TLV indicating Port TLV
Sub-TLV indicating timing information

In some instances, the TLVs for L2 stacking, AMI, and NM are in the private TLV space of the IETF ISIS packets. Such requests for private space will include four TLVs. It is noted that the exact values of these TLVS do not need to be sequential. Additionally, in some instances, the modified ISIS protocol may further be augmented to utilize encryption of fields for security considerations.

### Intra-Switch Forwarding Table

In embodiments, the intra-switch topology protocol is used to establish a forwarding FIB based on the processing of the topology information for the switches. The intra-switch stacking protocol uses VLAN/MAC mapping information to create the forwarding FIB table. The intra-switch topology protocol, in some instances, uses the VLAN/MAC mapping table created by a link state protocol to populate the forwarding FIB table for each virtual switch. In one embodiment, the intra-switch FIB table for each switch contains the following information: information related to a final switch, information related to a next-hop switch, information related to intra-switch interfaces to propagate the network packets.

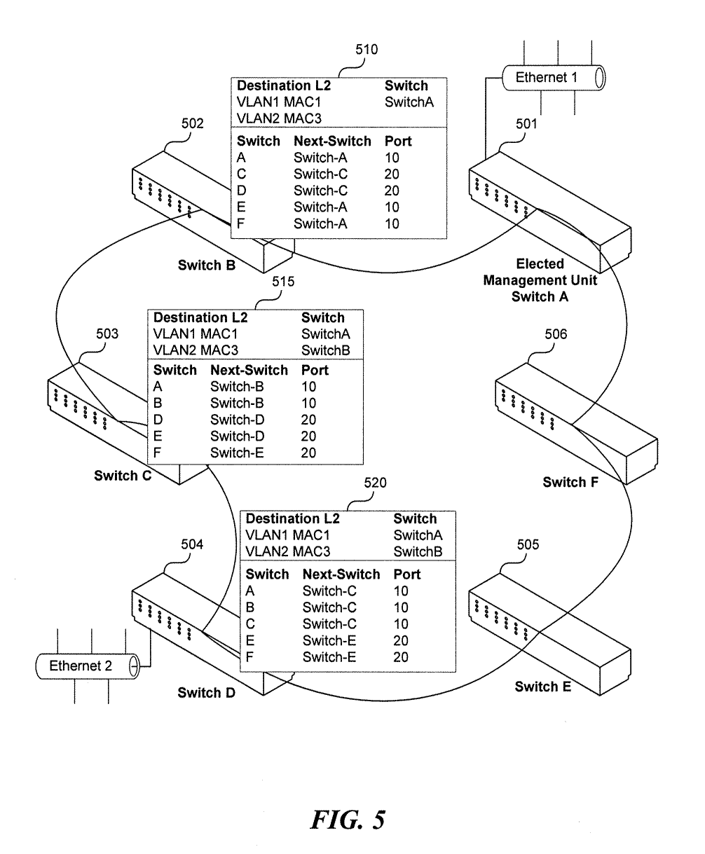

FIG. 5 depicts a stacked virtual switching environment that uses a FIB forwarding table for intra-switch communication. Switches A-F (501-506) are arranged in a virtual stacking environment. In an exemplary illustration, switch B 510 receives a MAC frame. Upon receipt of the MAC frame switch B uses a FIB forwarding table 510 to lookup the VLAN/MAC information to determine the next switch to forward the frame to, and also to lookup the intra-switch interface to be used. If the MAC frame has to traverse multiple switches, each intermediate switch in the traversal path looks up its own FIB forwarding table to route the frame to its final destination.

### Management Unit Failover And Election

As discussed in reference to FIGS. 1 and 2, the stacked virtual switch architecture has an elected management switch. Such an elected management switch may fail for several reasons (e.g., hardware failure, attack received through the network, etc.). In some instances, the intra-switch communication protocol starts a management election process to elect a new management switch from the list of remaining eligible virtual switches. The intra-switch communication protocol may start the election process, for example, after not receiving a heartbeat message from the current management switch.

In one embodiment, the management election process selects the new management switch based on, for example, a lowest switch-ID of the remaining eligible management switches. Other algorithms for selection of management switches, as understood by a person skilled in the art, are also suitable for election of the new management switch. The management agent of the elected management switch is then elected as a master agent.

In one embodiment, two types of management agents are identified: a topology master agent and a network management (NM) master agent. The topology master agent manages, for example, the intra-switch topology information, and the NM master agent manages, for example, the NM and AMI configuration information of the stacked virtual switches. In some instances, the election process of the intra-switch communication protocol includes two modes of election. The first mode, called a “joint” election mode, elects the management switch such that the topology master agent and the NM master agent reside in the same node of the management switch. The second mode, called a “disjoint” mode, elects the management switch such that the topology master agent and the NM master agent reside in two separate nodes of the elected management switch.

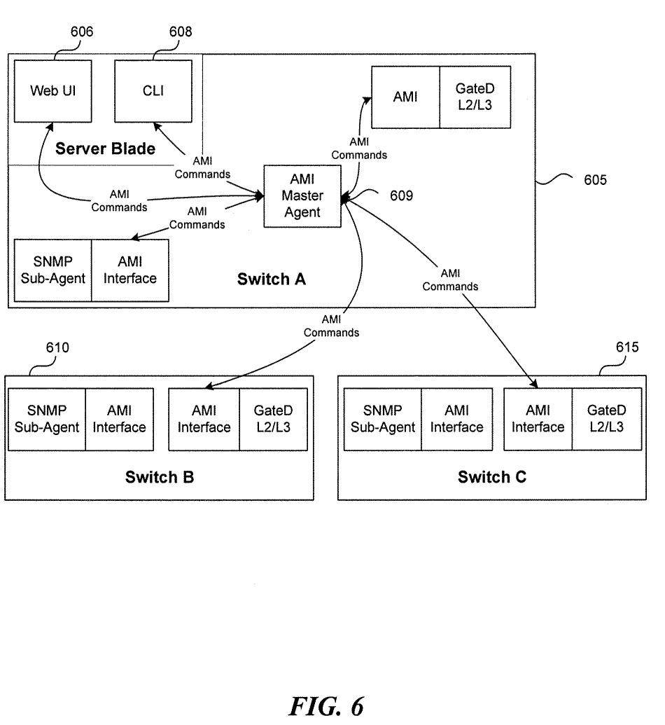

FIG. 6 depicts a stacked virtual architecture with an elected management switch 605. As previously discussed, each of the switches has a management agent to interface with a master agent 609 of the elected management switch 605. The management unit election process appoints the management agent of the newly elected management switch 605 as the master agent. This master agent may be a topology master agent to manage control nodes of the stacked virtual switches or a network management (NM) master agent. In one example, the master agent interfaces with the management agents of the remaining virtual switches (e.g., 610, 615) using AMI interfaces, as depicted in FIG. 6.

In one embodiment, the master agent provides an SNMP Agent-X/AMI interface in addition to an AMI/intra-switch protocol interface. The software for the master agent exists on all switches. In some instances, the software is maintained in the management agent of each of these switches. Although the software for the master agent is present in all switches, it is active only on the elected master. The software includes one or more of the following modules: SNMP sub-agent/AMI interface modules, AMI to inter-switch protocol interface, AMI master agent, etc. The master agent floods the configuration to all switches so that any switch may rapidly become an elected management switch subsequent to a failure of the currently elected management switch. The master agent is responsible for keeping the management agents of the remaining virtual switches updated with configuration changes. Additionally, the master agent provides user interfaces (e.g., CLI 608, Web UI 606, etc.) to enable communication with the master agent using, for example, AMI commands.

For processing of the AMI information, the intra-switch communication protocol either floods AMI packets to management agents of each switch, or uses a point-to-point interaction to communicate the AMI packet to a particular switch. For example, a master NM agent floods AMI sequences to the remaining management agents to update each switch's copy of a global NM database. The AMI information is unpackaged from the master NM agent and applied to the configuration tree. If any configuration change occurs to the switch (that contains the master agent), the GateD AMI engine of that switch is signaled with the changes to initiate, for example, the flooding of the AMI sequences.

In the event that a management switch is partitioned, the management switch has two master agents, one in each partition. If such a partition occurs, the election process of the intra-switch communication protocol elects a new master agent from the two master agents. The master agent that is not elected becomes a regular management agent of the respective partition.

The election process uses a list of management agents (from the stacked virtual switches) that are eligible to become a master agent. In embodiments, the list may exclude, for example, the management switches that were previously attacked. The list may also exclude management switches that can never be elected as a master management switch. The election process uses, for example, the TLV fields of the ISIS protocol to implement the list. In one illustrative example, the attacked NM masters TLV field provides a list of management agents that have previously been attacked.

### Stacking Switch To GateD Interaction

As previously discussed, GateD is altered to work with the intra-switch stacking protocol. A discussion of GateD implementations is provided in U.S. patent application Ser. No. 11/121162 entitled VIRTUALIZATION OF CONTROL SOFTWARE FOR COMMUNICATION DEVICES, filed May 2, 2005 (now abandoned), which is hereby incorporated by reference in its entirety. The following list provides an illustrative list of GateD modules that are changed to work with the intra-switch stacking protocol: SNMP interactions with each switch, AMI's configuration of GateD's L2, L3 and WAP functions, L2 MAC learning, VLAN learning, spanning tree packets (STP, RSTP, MSTP), ARP functions, L3 routing functions, etc.

The SNMP interactions are configured to support a sub-agent (e.g., Agent-X) interface to AMI. All queries to a switch are managed by this SNMP/AMI interaction. Upon failover (as herein described in subsequent sections), the SNMP master agent connects to the sub-Agent/AMI process to re-establish the SNMP configuration. The AMI master agent, for example, floods AMI configuration changes via the intra-switch flooding protocol. Individual queries via DGET or event reporting are reported directly to the AMI master agent.

In some instances, GateD's L2 processes receive information on MACs and VLANs. The MAC information learned from ports is handled by a MAC manager. Similarly, the VLAN information is handled by GVRP and the VLAN manager. These functions are utilized to spread the local switch information to other switches via the intra-switch protocol.

The L3 ARP information is sent via the intra-switch communication protocol to spread ARP information to all virtual switches. In some instances, the L3 routing functions are run on the master agent processor. The processing occurs in parallel with all other L3 processors. Additionally, GateD's synchronization protocol may be used to verify the L3 synchronization of FIBs.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

I claim:

1. A highly available computer network system comprising:
a plurality of processors;
a plurality of virtual switches residing in one or more of the plurality of processors, each of the plurality of virtual switches configured to perform switching functions on network packets received via a computer network, wherein the plurality of virtual switches are stacked in a selected topology and communicate with each other using an intra-switch communication protocol, wherein the intra-switch communication protocol prioritizes communication within the stacked virtual switches based on a type of intra-switch traffic;
an application programming interface including a plurality of operations configured to query and update each of the plurality of virtual switches, wherein a management agent included in each of the plurality of virtual switches responds to the plurality of operations of the application programming interface;
an elected management switch from the plurality of virtual switches, wherein the elected management switch is configured to manage topology and network management configuration of the plurality of virtual switches, wherein the elected management switch utilizes the application programming interface to forward the topology and network management configuration to the plurality of virtual switches, and wherein the elected management switch is elected from the plurality of virtual switches by operation of the intra-switch protocol.

2. The highly available computer network system of claim 1, wherein the selected topology is a single switch topology.

3. The highly available computer network system of claim 2, wherein the plurality of virtual switches are arranged in a meshed configuration.

4. The highly available computer network system of claim 2, wherein the plurality of virtual switches are arranged in a tiered configuration.

5. The highly available computer network system of claim 1, wherein the intra-switch traffic information includes one of:
identity configuration of the plurality of virtual switches;
topology configuration information of the plurality of virtual switches;
L2 information associated with the network packets;
network management configuration information of the plurality of virtual switches.

6. The highly available computer network system of claim 5, wherein the intra-switch communication protocol assigns a higher priority to the identity configuration and the topology configuration, and assigns a lower priority to the L2 information and the network management configuration during propagation of intra-switch traffic to the plurality of virtual switches.

7. The highly available computer network system of claim 6, wherein the management agent included in a given virtual switch of the plurality of virtual switches is operative to preempt lower priority intra-switch traffic in response to receipt of higher priority intra-switch traffic.

8. The highly available computer network system of claim 6, wherein the selected topology is operative to achieve a sub-second convergence subsequent to a failure of one or more of the plurality of virtual switches.

9. The highly available computer network system of claim 5, wherein the identity configuration of the plurality of virtual switches includes one or more of:
a virtual switch identifier;
a port information;
a hardware configuration.

10. The highly available computer network system of claim 5, wherein the topology configuration information includes a port information and a link information of the plurality of virtual switches.

11. The highly available computer network system of claim 1, wherein the management agent includes one or both of:
an Advanced Management Infrastructure (AMI) agent;
a Simple Network Management Protocol (SNMP) agent.

12. The highly available computer network system of claim 9, wherein the application programming interface includes one or both of:
an AMI interface;
an SNMP interface.

13. The highly available computer network system of claim 10, wherein the intra-switch communication protocol includes an intra-switch topology protocol.

14. The highly available computer network system of claim 13, wherein the management agent of each of the plurality of virtual switches stores a current state of the intra-switch topology protocol.

15. The highly available computer network system of claim 14, wherein the intra-switch topology protocol is a modified ISIS protocol.

16. The highly available computer network system of claim 15, wherein the intra-switch topology protocol includes a plurality of sub-components, each of the plurality of sub-components being one of:
a hello message to establish connection and heartbeat with the plurality of virtual switches;
a link-state PDU to update topology of the plurality of virtual switches;
an L2 information associated with the network packets;
a network management information associated with the plurality of virtual switches.

17. The highly available computer network system of claim 15, wherein the ISIS protocol is modified to include a Hello TLV field, the Hello TLV field including one or more of:
a link information of the plurality of virtual switches to identify the selected topology;
a network management sub-TLV field.

18. The highly available computer network system of claim 15, wherein an LSP of the ISIS protocol is modified to include:
a TLV for grouping of L2 stacking information associated with the plurality of virtual switches;
a TLV for configuration information associated with an AMI interface;
a TLV for election of the elected management switch;
a TLV for information associated with an Address Resolution Protocol (ARP).

19. The highly available computer network system of claim 18, wherein the TLV for grouping of L2 stacking information includes:
an L2 stacking information sequence;
a group identifier;
sub-TLVs including one or more of: a Port-ID list, a VLAN list; a MAC list, a time value for the MAC list, a queue load value with flags for queue prioritization, status information for each of the plurality of virtual switches, switch capability information, a protocol encapsulation.

20. The highly available computer network system of claim 18, wherein the TLV for configuration information associated with the AMI interface includes:
an AMI sequence;
an identifier of an AMI originator;
an identifier of an AMI destination;
sub-TLVs including one or more of AMI TLVs.

21. The highly available computer network system of claim 18, wherein the TLV for the election of the elected management switch includes sub-TLVs for one or more of: a heartbeat, a list of permitted elected management switches, a list of denied elected management switches, a list of attacked management switches.

22. The highly available computer network system of claim 18, wherein the TLV for the information associated with the ARP includes sub-TLVs for one or more of: an ARP pairing, a port TLV, a timing information.

23. The highly available computer network system of claim 15, wherein the intra-switch topology protocol creates an intra-switch FIB table for each of the plurality of virtual switches to establish a sequence for forwarding network packets, and wherein the intra-switch FIB table of each of the plurality of virtual switches includes one or more of:
information associated with a final switch in the selected topology;
information associated with a nexthop switch in the selected topology;
one or more intra-switch interfaces to be transmitted within the selected topology.

24. The highly available computer network system of claim 21, wherein the intra-switch topology protocol utilizes a switch mapping table created by a link state protocol to create the intra-switch FIB table.

25. The highly available computer network system of claim 15, wherein the intra-switch topology protocol initiates the election routine subsequent to detecting a failure of a current elected management switch.

26. The highly available computer network system of claim 25, wherein the intra-switch topology protocol selects a new elected management switch from a subplurality of eligible virtual switches.

27. The highly available computer network system of claim 26, wherein the subplurality of eligible virtual switches excludes previously attacked switches of the plurality of virtual switches.

28. The highly available computer network system of claim 26, wherein the management agent of the new elected management switch uses a flooding protocol to flood a new network management configuration to the management agents of the remaining plurality of virtual switches.

29. The highly available computer network system of claim 26, wherein the new elected management switch includes a topology master agent and a network management master agent.

30. The highly available computer network system of claim 29, wherein the election routine utilizes a joint election mode to elect a new elected management switch, wherein the joint election mode enables the topology master agent and the network management master agent to reside in a single node of the new elected management switch.

31. The highly available computer network system of claim 29, wherein the election routine utilizes a disjoint election mode to elect a new elected management switch, wherein the disjoint election mode enables the topology master agent and the network management master agent to reside in discrete nodes of the new elected management switch.
